(19) United States
(12) Patent Application Publication
(10) Pub. No.: US 2015/0235160 A1
(43) Pub. Date: Aug. 20, 2015

(54) GENERATING GOLD QUESTIONS FOR CROWDSOURCING

(71) Applicant: Xerox Corporation, Norwalk, CT (US)

(72) Inventors: Diane Larlus-Larrondo, La Tronche (FR); Vivek Kumar Mishra, Lucknow (IN); Pramod Sankar Kompalli, Hyderabad (IN); Florent C. Perronnin, Domene (FR)

(73) Assignee: Xerox Corporation, Norwalk, CT (US)

(21) Appl. No.: 14/184,936

(22) Filed: Feb. 20, 2014

(51) Int. Cl. G06Q 10/06; G06F 21/30

(52) U.S. Cl. CPC G06Q 10/06398; G06F 21/30

(57) ABSTRACT

A system and method for generating gold questions for labeling tasks are disclosed. The method includes sampling a positive class from a predefined set of classes to be used in labeling documents, based on a computed measure of class popularity. A set of negative classes is identified from the set of classes based on a distance measure between the positive class and other classes in the set of classes. A gold question is generated which includes a document representative of the positive class and a set of candidate answers. The candidate answers include a label for the positive class and a label for each of the negative classes in the identified set of negative classes. A task may be generated which includes the gold question and a plurality of standard questions which each include a document to be labeled. A computer processor may implement all or part of the method.

### BACKGROUND

The present application relates to crowdsourcing multi-class classification tasks and finds particular application in connection with a system and method for improving reliability of task responses.

Crowdsourcing is a mechanism by which tasks can be completed by a large number of often unknown, distributed workers (crowdworkers). There are several advantages of crowdsourcing tasks. For example, the workforce is available immediately, without the need to recruit or maintain workers on a payroll. Workers are generally available at all times of the day or year. Additionally, the workforce can be diverse, spanning several countries, age-groups, and demographics. Since workers can choose what they want to work on, they tend to have greater satisfaction in doing the work, and thus may be expected to pay higher attention to the tasks that they perform.

Several problems have been successfully crowdsourced, such as form digitization, survey completion, verification of webpage details, and the like. The problem is posed in the form of a Human Intelligence Task (HIT), which is a small unit of work that can be solved within a reasonable amount of time by a single crowdworker.

In the case of multi-class classification tasks, workers are given a query “document” (such as a textual document, an image, a video, or the like) and are asked to annotate it with a correct class label, are given a class label and asked to find documents corresponding to the class label, or are given a document and a class label and are asked to confirm the presence of the label in the document. The labeling task is typically a goal in itself, with the additional advantage that such labels can be subsequently used to train or improve an automated labeling system. The task is often provided to the workers as a multiple choice question: given the document and a set of candidate classes, the worker should select one class within this restricted set. The candidate classes may be the top-k outputs of an automatic classification system, or may be selected using some prior or complementary information (for example, the meta-data of an image). Limiting the worker's selection choices in this way is advantageous when there is a very large number of possible classes (e.g., several hundreds or thousands) and when browsing the complete list of classes would be unmanageable. It is also useful when the task is too difficult to be solved by humans or computers alone and when their complementarity can be leveraged.

Conventionally, image annotation tasks employing crowdsourcing correspond to a small number of easily distinguishable classes (e.g., “distinguish the following four classes: car, bus, truck, and bicycle”). In the simplest setting, there are only two classes and the task involves providing a binary answer (e.g., “does this image contain a car?”). Such tasks generally do not require specific skills and very high accuracy can be expected, even from unskilled workers.

However, reliable crowdsourcing results for even simple tasks are not always guaranteed. This may be because the crowdworkers do not have the right backgrounds to understand the task and do a good job, or because they wish to minimize the effort expended. Random answers are sometimes generated by bots. One mechanism to identify unreliable workers is to hide what is called a “gold question” in the HIT. This is a question for which the answer is known a priori. The assumption is that, if a worker provides the correct answer for the gold question, then the worker is likely to provide reliable answers for the rest of the task. However, gold questions are often easy for the worker to spot. As an example, the question may specify which of the possible answers is to be selected. This type of gold question is generally only useful for identifying random answers. Crowdworkers are often aware of the presence of the gold question, which can motivate them to search for the gold question and answer it correctly. They can then be remunerated for performing the task without doing reliable work on the other questions in the HIT. To address this problem, a good gold question should be easy enough to answer by a sincere worker while not being easily detectable.

Designing gold questions is not difficult for simple problems, such as the four-class vehicle labeling task mentioned above, where a high accuracy from the workers is expected (100% or very close to it). In such cases, the gold questions may be sampled randomly from the standard questions posed to the workers. The corresponding image is annotated a priori to perform the check.

However, gold questions tend to be expensive to generate on a large scale. To address this, an automated mechanism of generating gold questions has been proposed in Oleson, et al., “Programmatic gold: Targeted and scalable quality assurance in crowdsourcing,” Human Computation, 2011 AAAI Workshop, pp. 43-48 (2011). Oleson generates new gold questions by adding different types of noise to an initial gold question. The approach is demonstrated on text questions with Yes/No answers. This technique, however, cannot be successfully applied to image data, since transforming images to generate a different appearance could be more easily detected by the worker. In other tasks, images of a control word and a test word are provided to the user to type-in. The text of the control word is used to verify the input and the test word's text is stored in the database. However, as workers become more aware, they are able to distinguish easily between the control and test word, allowing them to manipulate the system.

Another method of checking a crowdworker's answer is by comparing it with that of another, randomly selected crowdworker. See, von Ahn, et al., “Labeling images with a computer game,” Proc. SIGCHI Conference on Human Factors in Computing Systems, CHI '04, pp. 319-326 (2004). The process of redundancy exploits the likelihood that two un-cooperating workers would provide the same answer only if they both answer correctly. This method is suitable for tasks that require text or similar forms of input, but is less reliable with tasks that are multiple-choice, such as in the case of multi-class image labeling, particularly when the task is difficult.

There remains a need for a system and method for generating gold questions which can improve reliability of responses from crowdworkers, particularly in image-classification tasks.

### INCORPORATION BY REFERENCE

The following references, the disclosures of which are incorporated herein by reference in their entireties, are mentioned:

US Pub. No. 20130185138, published Jul. 18, 2013, entitled FEEDBACK BASED TECHNIQUE TOWARDS TOTAL COMPLETION OF TASKS IN CROWDSOURCING, by Shourya Roy, et al.

US Pub. No. 20130324161, published Dec. 5, 2013, entitled INTUITIVE COMPUTING METHODS AND SYSTEMS, by Geoffrey B. Rhoads, et al.

### BRIEF DESCRIPTION

In accordance with one aspect of the exemplary embodiment, a method for generating a gold question for a labeling task includes sampling a positive class from a predefined set of classes to be used in labeling documents, based on a computed measure of class popularity. For the positive class, a set of negative classes is identified from the set of classes based on a distance measure between the positive class and other classes in the set of classes. A gold question is generated which includes a document representative of the positive class and a set of candidate answers. The candidate answers include a label for the positive class and a label for each of the negative classes in the identified set of negative classes. The gold question is output.

One or more of the sampling, identifying, and generating may be performed with a computer processor.

In accordance with another aspect of the exemplary embodiment, a system for generating a gold question for a labeling task includes a positive class selector for sampling a positive class from a predefined set of classes to be used in labeling documents, the sampling being based on a computed measure of class popularity. A negative class selector identifies a set of negative classes from the predefined set of classes based on a distance measure between the positive class and other classes in the set of classes. A gold question generator generates a gold question that includes a document representative of the positive class and a set of candidate answers, the candidate answers including a label for the positive class and a label for each of the negative classes in the identified set of negative classes. A task outsource component outputs a task that includes the gold question. A computer processor implements the positive class selector, negative class selector, and gold question generator.

In accordance with another aspect of the exemplary embodiment, a method for generating a human intelligence task includes computing a measure of popularity for each of a set of classes to be used in labeling documents. A positive class is sampled from the set of classes based on the computed measure of popularity. A set of negative classes is identified from the set of classes based on a distance measure between the positive class and other classes in the set of classes. A gold question is generated which includes a document representative of the positive class and a set of candidate answers. The candidate answers include a label for the positive class and a label for each of the negative classes in the identified set of negative classes. A human intelligence task is generated. This includes combining the gold question with a set of standard questions, each of the standard questions including a document to be labeled and a set of candidate answers. The candidate answers include labels for at least a subset of classes from the set of classes. The human intelligence task is output.

At least one of the computing, sampling, identifying, generating the gold question, and generating the task may be performed with a computer processor.

### BRIEF DESCRIPTION OF THE DRAWINGS

FIG. 1 is a functional block diagram of an system for automated generation of gold questions for annotation tasks in accordance with one aspect of the exemplary embodiment;

FIG. 2 illustrates a graphical user interface in accordance with another aspect of the exemplary embodiment;

FIG. 3 is a flow chart illustrating a method of formulation of a gold question in accordance with another aspect of the exemplary embodiment; and

FIG. 4 is a list of the ten most popular classes (here, species of birds) among a set of 200 North-American birds, together with a labeled set of photographs of each of these bird species.

### DETAILED DESCRIPTION

Aspect of the exemplary embodiment provide an automatic approach to designing gold questions for multiple-choice crowdsourcing tasks that combines class popularity to choose the query classes and class-to-class distance to choose the negative classes.

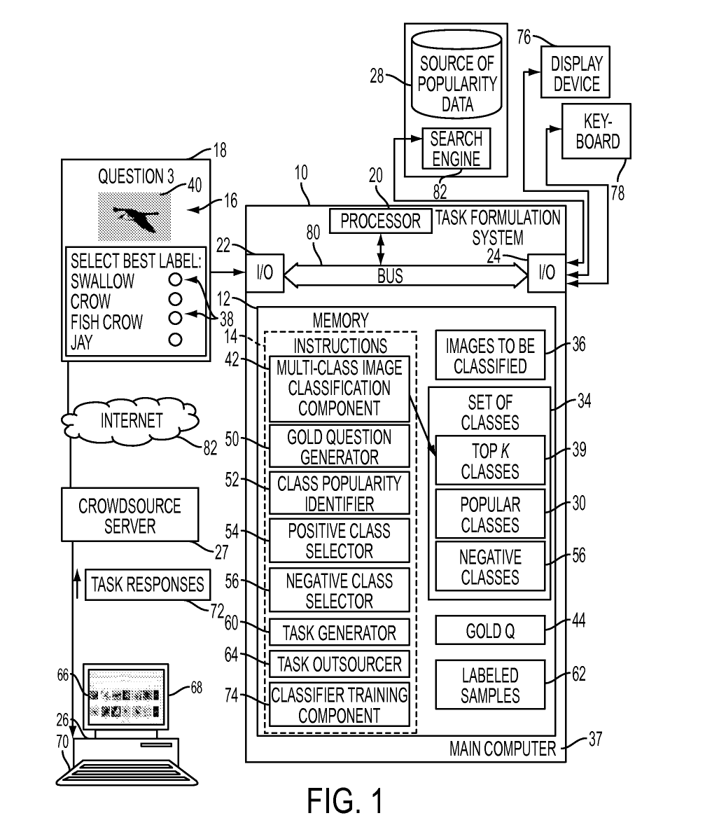

With reference to FIG. 1, a computer-implemented system 10 for formulation of gold questions for annotation tasks is shown. The system includes memory 12 which stores instructions 14 for generating gold questions 16 to be incorporated into crowdsourcing tasks 18 and a processor 20 in communication with the memory for executing the instructions. The system 10 includes one or more network interfaces 22, 24, for communicating with external devices, such as client devices 26 operated by persons serving as crowdworkers (human annotators). In an exemplary embodiment, communication with crowdworkers is via an intermediate server 27 which provides an Internet crowdsourcing marketplace (such as the Amazon Mechanical Turk). The intermediate server 27 may host a web portal for providing workers with access to a database of tasks 18, receiving the responses from workers to their selected tasks, and making payments to the workers. The payments may be financial or non-monetary payments, and in some cases, may be negative payments, such as a reduction in the crowdworker's rating. In other embodiments, the system 10 may communicate directly with crowdworkers. The system 10 is also in communication with a source 28 of popularity data which is used to identify a subset of popular classes 30 from a larger, predefined set 34 of classes that is to be used in labeling a collection 36 of documents. The system 10 may be hosted by one or more computing devices, such as the illustrated main computer 37 and/or crowdsource server 27.

The exemplary system 10 is designed to facilitate outsourcing multi-class classification problems that consider a large number of classes 34 and for which a perfect accuracy from workers cannot be expected. In particular, the system 10 facilitates outsourcing tasks 18 in which workers select a label 38 from a predefined set 39 of class labels for each of a subset of the documents 36. The documents may all be of a same document type. The document type may be selected from images, videos, text documents, audio, or other type of digital document. Each label in the set 39 of labels corresponds to a respective one of the classes 34. In the case of photographic images as documents, each of the classes may correspond to a type of visual object, such as an animal species, bird species, plant species, type of vehicle, type of form that has been/is to be filled in, or the like. An example of such a task is the classification of a bird image 40 according to its species, although the method is applicable to other crowdsourced systems for labeling images, other types of visual data such as video, textual documents, audio documents (e.g., music snippets), and mixed modality documents. The document labeling task may be a goal in itself, or the labels can be subsequently used to train or improve an automated classification component 42 which includes one or more classifiers.

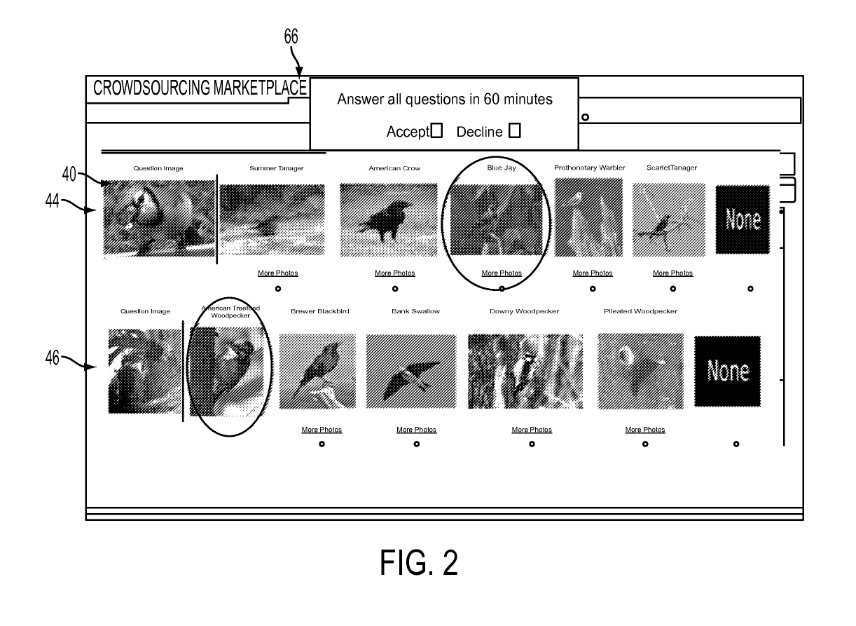

The exemplary system and method facilitate the design of gold questions 44 for such difficult multi-class classification problems. Each gold question has the same format as the other questions (denoted “standard questions”) in a human intelligence task (HIT). Thus, for example, if the task is labeling bird images using a species label selected from a set 34 of species labels, the gold question also calls for labeling a bird image 40 by selecting a species label 38 from a set 39 of candidate species labels 38. There may also be provision for the worker to select “none” to indicate the worker considers that none of the candidate species labels is appropriate. See, for example, FIG. 2, where the true label for each query image 40 is highlighted for illustration only. In the case of the gold question 44, the true label for the document 40 to be labeled is known in advance, whereas for the standard questions 46 in the HIT, the goal is to have the workers, singly or jointly, provide the label for the document. In designing each gold question 44, the aim is to have questions 44 which are easy enough so that workers can answer them reliably while being difficult enough not to be spotted as being gold questions too easily. In the exemplary embodiment, the design of gold questions for multiple-choice tasks such as these uses two measures: (i) a measure of the popularity of the classes in the set of classes 34 and (ii) a measure of, distance between each popular class and other classes in the set of classes 34.

The method is suited to crowdsourcing of difficult tasks that have many classes (e.g., at least 20, or at least 100 classes, and up to 10,000 or more classes, e.g., up to 500 classes) which may be difficult to distinguish, even for a human. This is the case of fine-grained classification problems where the classes correspond to visually similar and semantically-related classes, e.g., bird species, dog breeds, types of vehicles and other product types, document forms, and so forth. Here, the assumption can be made that the classes are so similar to each other or so specialized that only an expert can answer the questions with high accuracy.

In the exemplary embodiment, the task is an image labeling task which is provided as a multiple choice question: given the image 40, and a set 39 of candidate classes, the worker should select one class label 38 within this restricted set. These candidate classes 39 may be, for example, the top-k outputs of the automatic image classification component 42. This is suited to the case where there is a very large number of classes such that browsing the complete list of classes would be unmanageable. It also offers an opportunity to combine the complementary strengths of humans and computer algorithms. For the bird labeling task, for example, the average worker may have a poorer performance than the automatic classification component 42.

For such complex tasks, the simple random sampling approach to designing gold questions is not very reliable. Indeed, in such a case, a worker might not be able to answer a question, not because he or she is insincere but because the worker is not skilled enough. This distinction is significant, as the insincere workers should not be rewarded (and their answers should not be taken into account), while the reliable ones should. The design of reliable gold questions for such complex problems is therefore invaluable to retaining skilled workers while also obtaining reliable results. In one embodiment, given a trained classification component 42, the system 10 generates gold questions 44 entirely automatically. In other embodiments, at least a part of the process is manual.

An aim is that gold questions comply with the two following properties:
1. Gold questions should be easy enough so that the average accuracy of an annotator is as close to 100% as possible, and consequently can still be an accurate indicator of the worker sincerity.
2. Gold Questions should be as close as possible to the standard questions in the annotation problem so they are difficult to detect.

In the case of multiple choice tasks 18, the gold question is, like the standard questions, a multiple choice question. One query image 40 and several candidate labels 38 (e.g., 5 choices) are provided. The crowdworker is asked to select the most appropriate label. In the case of standard questions, the correct label may not always be among the choices, since, for example, the classifier 42 does not always identify the correct class among the top five 39. For the gold questions, however, it is desirable that the correct class is within the set of candidate choices. In such a case, the correct class (which is known a priori) is later referred to as the positive class while the other classes are referred to as negative classes. In some cases, additional information beyond the class labels may be provided to the worker to assist the worker in making a decision, e.g., in the case of an image 40 to be labeled, a textual description and/or one or more pre-labeled images corresponding to each of the candidate labels may be provided. In other cases, only the labels are provided.

The system 10 includes gold question generator 50 for generating gold questions 44. The gold question generator 50 includes or calls on a class popularity identifier 52 which computes a popularity of each (or at least some) of the classes in the set 34 and which may identify a subset of popular classes 30 from the predefined set of classes 34. A positive class selector samples (i.e., selects) a positive class, e.g., from among the set of popular classes 30. A negative class selector 56 computes distances between classes in the set 34 and, for each positive class, identifies a set 58 of negative classes, based on the distances, to bias the sampling of a gold question 44 toward being a simpler question. The gold question generator 50 retrieves a document, such as an image 40 for the positive class from a set of pre-labeled samples 62 and randomly orders the positive class label and the identified negative labels as a gold question.

A task generator 60 incorporates the gold question(s) 44 output by the gold question generator 50 into a set of questions forming the task 18. Each task may include at least one gold question 44 and a set of standard questions. Each of the standard questions includes one of the set 36 of images to be classified and a set 39 of candidate labels, e.g., the top-k class labels output by the classifier 42. The task 18 is then outsourced by a task outsourcing component 64 to a set of one, two or more crowdworkers for executing the task (e.g., by submitting the task to the crowdsourcing Internet market place). Crowdworkers then answer each of the questions, including the gold question, by selecting an appropriate label. The outsourcing component 64 may generate a graphical user interface 66 for display to the human annotator on a respective display device 68 (e.g., an LCD screen or computer monitor) of the client computing device 26 in which the gold question 44 and standard questions 46 are graphically displayed (see FIG. 2, where the correct answers are highlighted for illustration purposes only). As noted above, the gold question 44 is not identified as such to the human annotators performing the task. The crowdworker uses a user input device 70, such as a keyboard, touch screen, cursor control device, combination thereof, or the like, to click on or otherwise select an answer to each question, i.e., one of the candidate labels. The task outsourcing component 64 (or a component of a separate computing device) receives the responses 72 from the crowdworkers and analyses the responses to the gold questions 44 to determine the reliability of each of the crowdworkers. For example, crowdworkers which answer all (or at least a threshold amount, e.g., in terms of number or proportion) of the gold question(s) correctly are considered reliable and their answers to the standard questions 46 may be used to generate labels for the documents 36 to be classified and/or employed by a classifier training component 74 to retrain the classification component 42 or to train a new classifier. As will be appreciated, some of the software components 42, 50, 52, 54, 56, 60, 64, 74 may be hosted, at least in part, by the crowdsource server 27 and/or another computing device.

Where the gold questions 44 are generated partially manually, e.g., by having an operator review and validate the gold questions, the I/O interface 24 may communicate with one or more of a display 76, for displaying information to users, and a user input device 78, such as a keyboard or touch or writable screen, and/or a cursor control device, such, as mouse, trackball, or the like, for inputting text and for communicating user input information and command selections to the processor 20. The various hardware components 12, 20, 22, 24 of the computer 37 may be all connected by a bus 80.

The computer system 10 may include one or more computing devices 27, 37, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 20 and memory 12 may be combined in a single chip. Memory 12 stores instructions for performing the exemplary method as well as the processed data 30, 39, 44, 56.

The network interface(s) 22, 24 allows the computer 37 to communicate with other devices via one or more wired or wireless links 82, such as a computer network, e.g., a local area network (LAN) or wide area network (WAN), such as the Internet, and may comprise a modulator/demodulator (MODEM) a router, a cable, and and/or Ethernet port.

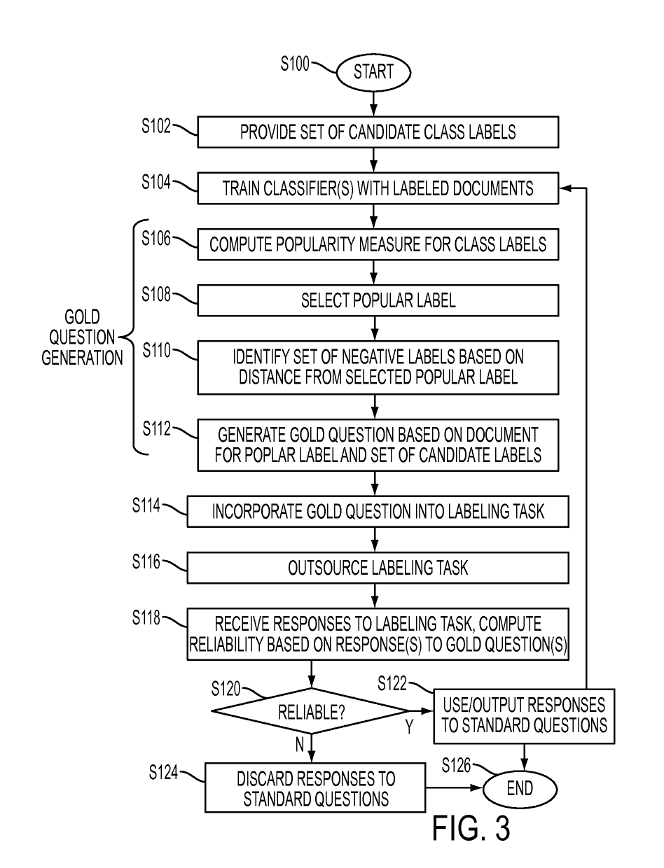

The digital processor 20 can be variously embodied, such as by a single-core processor, a dual-core processor (or more generally by a multiple-core processor), a digital processor and cooperating math coprocessor, a digital controller, or similar device. The digital processor 20, in addition to controlling the operation of the computer 37, executes instructions stored in memory 12 for performing the method outlined in FIG. 3.

Client computer 26 and server computer 27 may be similarly configured to computer 37, except as noted, with memory, a processor, and a network interface.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 1 is a high level functional block diagram of only a portion of the components which are incorporated into a computer system 10. Since the configuration and operation of programmable computers are well known, they will not be described further.

The method for the design of gold questions 44 for complex multiple-choice classification tasks relies on two factors to choose the positive and corresponding negative classes. The first is class popularity and the second is class similarity/distance. Class popularity is used to sample positive classes. Then the class distance is used to sample negative classes. The system also provides a balance between the “easy enough” and “not too easy” considerations.

FIG. 3 illustrates the exemplary method which may be performed with the system of FIG. 1. The method begins at S100.

At S102 a set 34 of labels (corresponding to classes) for applying to unlabeled documents 36 is provided.

At S104, using a set of labeled training documents 62, a binary classifier 42 may be trained by the classifier training component 74 for each of the labels in the set 34 or a multiclass classifier may be trained over all the labels.

At S106, for each (or at least some) of the labels in the set 34, a measure of popularity is computed for the respective class by the class popularity identifier 52 using information extracted from the source of popularity data 28.

At S108, one or more popular classes 30 may be selected from the set 34 of classes by the positive class selector 54, based on the measure of popularity computed at S106.

At S110, for one of the popular classes (the positive class), a set of one or more negative classes (i.e., fewer than all the other classes, e.g., at least 2 or at least 3 negative classes) is selected by the negative class selector 56, based on a measure of distance from the positive class.

At S112 at least one gold question 44 is generated. In particular, a document, e.g., an image 40, that has, as its label, the label of the positive class, is selected from the labeled samples 62 by the gold question generator 50. Labels 38 of the negative classes and the positive class are randomly ordered in association with the selected document 40 as candidate answers with a request to identify the correct answer from the set of candidate answers (the candidate answers may also include an answer which allows the annotator to select none of the labels).

At S114, a task 18 is generated by combining the gold question 44 with a set of similar, standard questions 46 without distinguishing between the gold question and the standard questions in the task. For each standard question 46, an unlabeled document from the set 36 is selected to be labeled with labels from a set of candidate labels, e.g., the top k class labels 39 output by the trained classifier(s) 42. As an example, there may be at least two or at least three standard questions per HIT 18, and in some embodiments, up to 20 or more standard questions, with generally more standard questions in a HIT than gold questions.

At S116, the task 18 is output for crowdsourcing by the task outsourcer 64.

At S118, the responses 72 are received from human annotators and checked by the task outsourcer 64 for reliability, e.g., by comparing the answer to each gold question 44 with the true answer. If the gold question is answered correctly (or all or a portion of two or more gold questions are answered correctly), the rest of the (standard question) answers are considered reliable (S120) and may be output/used to determine labels for the unlabeled documents and/or to update the training of the classifier 42 (S122). Otherwise, at S124, the responses to the standard questions may be discarded or otherwise treated differently (e.g., by weighting their relevance in assigning labels to the standard questions with a weight which is lower than for the answers provided by crowdworkers which answered the gold questions with greater accuracy).

The method ends at S126.

The method illustrated in FIG. 3 may be implemented in a computer program product or products that may be executed on a computer or computers. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 18, (for example, an internal hard drive of RAM), or may be separate (for example, an external hard drive operatively connected with the computer 18), or may be separate and accessed via a digital data network such as a local area network (LAN) or the Internet (for example, as a redundant array of inexpensive of independent disks (RAID) or other network server storage that is indirectly accessed by the computer 18, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the method. As will be appreciated, while the steps of the method may all be computer implemented, in some embodiments one or more of the steps may be at least partially performed manually.

Further details of the system and method will now be described.

### Class Labels (S102)

As noted above, the class labels are related to the task to be performed, such as bird species labels. For each label, a set of training examples 62 is obtained. In the case of images, for example, these may be obtained from a website in which images of the type to be labeled are given labels or other descriptive information sufficient to allow a class label to be assigned. In other embodiments, the labeled samples 62 may be generated from the set of documents (e.g., images) 36 to be classified, or from a separate set of images, by having an expert label them manually.

### Sampling a Positive Class Using Popularity (S106, S108)

Even for overall difficult classification (or labeling) problems, some classes are easier to recognize for an annotator than others, so they constitute good candidates from which to choose the query image 40 for a gold question 44. The assumption is that common, i.e., more popular, classes will be easier to recognize for a non-expert. The exemplary method employs a quantitative measure of class popularity. By way of example, one or more of the following quantitative measures is/are employed to identify popular classes from which the positive class may be sampled:

1. Quantity of mentions of the class label which are identified in a search. In this approach, it is assumed that a class is popular if it is more commonly discussed on web-pages than other classes. Consequently, the number of hits that a text search engine (such as Google search) returns when queried with the class label (and/or other name for the class) can be used as the measure of popularity for each class. To assist in ensuring that the search engine is identifying relevant hits, further information may be added to the search to exclude or limit the quantity of non-relevant hits. For example in the case of bird species, the word “bird” could also be used in the search. In general, it is not necessary to be familiar with the way in which the search engine 82 determines the number of hits, e.g., as the number of documents containing the class label (or related word), the total number of occurrences, or a combination thereof. Rather, the number of results or similar information (e.g., search time) displayed by the search engine can be used to compute the measure of popularity.

2. Quantity of documents (e.g., images, when the documents to be classified are images) labeled with the class which are identified in a document-type search. In this approach, it is assumed that a visual class is popular if it is more commonly photographed and shared over the Internet. Consequently, as a popularity measure, the number of hits an image search engine 82 (such as Google image search) returns when queried with the class label (or other common name for the class) can be used. While this approach is particularly suited to photographs (single images), it can be extended to video by querying video-sharing websites, such as YouTube. As with the first approach, the search may be limited with additional search terms to exclude or limit the quantity of non-relevant hits.

3. Quantity of groups focusing on the class or quantity of documents submitted to those groups. In this approach, photo-sharing websites, such as Flickr™ can be leveraged to measure the popularity. Flickr allows users to join groups which can be manually or otherwise associated with the class labels. In one embodiment, the number of groups which deal with the given class can be counted as a measure of class popularity. Another measure could include such counts as the number of images posted on the group(s) related to the class or the number of comments. An aggregation of such measures may be employed. This aspect can be extended beyond visual data, for example, to other domains, by mining specialized forums, e.g., music forums, in the case of classifying music snippets according to the artist or genre, for example. More generally, any social media can be analyzed to serve this purpose.

These example techniques for measuring popularity all rely on the mining of public resources as the source 28 of popularity data. In particular, they rely on human data, i.e., what a person considers meaningful, rather than relying on machine classification techniques. However, it is also contemplated that automated trained classifiers could be used to assign labels to documents, e.g., on a website or across several websites and/or databases, in order to assist in identifying the most popular class labels. In other embodiments, questionnaires or other methods could be employed to identify the most popular labels. This may be useful when surrounding information from the webpages can be used. A combination of different approaches to computing a popularity measure may be employed.

To take into account the specificity of the workers and especially their cultural differences, different resources 28 can be mined for different workers. For example, if the task is bird classification, a popular bird in North America may be quite different from a popular bird in India. Hence, where location information about the worker can be collected (e.g., provided voluntarily, or extracted from the IP address) the popularity measure query can be performed on the relevant search engine, e.g., www.google.com for workers located in North America vs www.google.co.in for workers in India. Depending on the task, this could involve translation of the class names into relevant languages.

In one embodiment, the classes may be ranked according to popularity, based on their respective popularity measures. For example, the most popular class is ranked 1, with the less popular classes having higher numbers. The top ranked classes, e.g., the p most popular classes (p may be a number or predetermined percent of the classes) may be identified. In general, p may be less than 20%, or less than 10%, of the total number of classes to be used in labeling documents, such as from 1-20, or at least 2, or at least 4, or up to 10 classes, or more. A class may then be sampled (e.g., selected randomly with a uniform probability over the classes) from this pool 39 of classes as the query class for each gold question. In other embodiments, classes may be sampled from the set of classes 34, or from a larger pool of more popular classes based, at least in part, on their respective class popularity, e.g., each class is sampled with a probability which is an increasing function of its class popularity.

At least one query image 40 (or more generally, a document) for each of the set 30 of p popular classes is provided. For this purpose, a set of sample documents 62 may be provided for each class (more than one labeled sample is desirable to avoid always showing the same image, which could make the gold question easy to spot after some time). The samples 62 may be drawn from the set of labeled images used to train the classifiers 42, or from a separate set of labeled images.

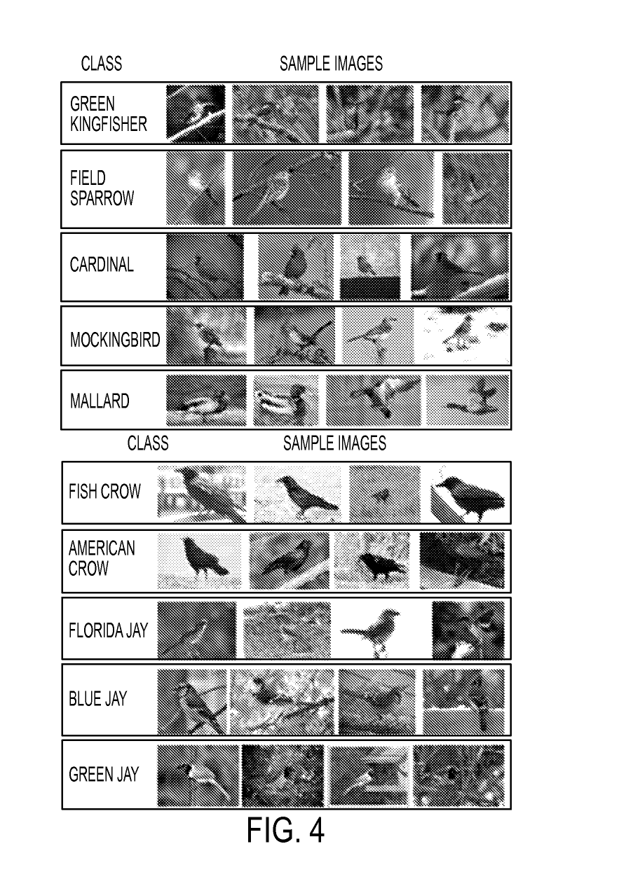

As an example, FIG. 4 shows the ten most popular bird classes according to an image search in www.google.com, together with randomly selected photographic images of these bird species. These are bird species which would likely be familiar even to non-experts for people living in North America.

### Sampling Negative Classes Using Class Distances (S110)

In fine-grained problems, two sub-classes can be very similar, but pairs of classes can be chosen to be different enough so that even a non-expert will easily distinguish them. For the gold question 44, negative classes are selected so that a worker will be reasonably confident that the query image does not belong to any of these classes. For this purpose, the classes are embedded in a space in which a distance between classes is measurable. This embedding process, and the resulting distance, is chosen to reflect the similarity between two classes as perceived by a non-expert annotator. It has been found that the co-occurrence of two words corresponding to two visual classes on the same web page is only weakly indicative of their visual similarity, and thus is generally not a useful distance measure, although it is contemplated that may be used as one feature. By way of example, two useful approaches to perform such an embedding include: a) using a priori information, or b) using labeled images (i.e., data-driven).

a. Class Embedding Using a Priori Information

In this embodiment, one or more different sources of a priori information may be used to embed classes in an embedding space, such as a Euclidean space. Examples of a priori information include attributes and ontologies:

1. Attribute-based embedding: visual classes can often be described by a list of attributes. For example, a bird species can be described by the shape of its beak or the color of various parts of its plumage. Suitable attributes are those for which a measure of the relevance of the attribute with respect to each class can be expressed with a relevance factor. This relevance factor may be binary (indicating presence or absence of the attribute) or it may be real-valued if information on the strength of the relevance can be determined. Such attributes and relevance factors can be mined, for example, from field guides or other textual resources generated by experts. In such a case, the embedding of a given class is a vector whose dimensionality equals the number of attributes and which encodes the attribute-to-class relevance. For example, at least ten or at least twenty attributes are employed, and in some cases, several hundred attributes are used. In some embodiments, each class may have a unique vector of attributes. In other embodiments, very similar classes may sometimes have the same vector.

2. Ontology-based embedding: some classes can be naturally organized as a hierarchy, or as an ontology (this is common for animals and plants, but can also be applied to many other objects, such as car types). In such a case, the position of the class in the ontology is used to generate an embedding. An example embedding for a given classy is a binary vector whose dimensionality is equal to the number of classes in the ontology and such that the value of the d-th dimension is 1 if d=y or if d is an ancestor of y.

In some embodiments, two or more different sources of a priori information may be combined to obtain the embeddings, e.g., by concatenating or otherwise aggregating the two or more embeddings. See, also Zeynep AKATA, et al., “Label-Embedding for Attribute-Based Classification,” IEEE Computer Vision and Pattern Recognition (CVPR), pp 819-826 (June 2013), for details on other class-embeddings based on a priori information and their combinations which are useful herein.

The distance between a selected positive class and each other class can be computed, e.g., as the Euclidian distance, Manhattan (L1) distance, or other distance measure between their respective vectors. For each class, a set of the n most distant classes can then be identified, based on the computed distance measures, from which negative classes can then be sampled for the gold question. For example, using Euclidean distance in a class-embedding using a bird ontology as defined by a field guide for the class “Laysan Albatross”, the five closest classes (among 200 classes) were computed as Black-footed Albatross, Sooty Albatross, Horned Puffin, Northern Fulmar, and Pelagic Cormorant. The five furthest classes, which could serve as the negative classes in this example, were determined to be American Redstart, Yellow-breasted Chat, Boat-tailed Grackle, Bronzed Cowbird, and Shiny Cowbird.

b. Data-Driven Class Embedding

In this embodiment, class-to-class similarity is measured by using labeled training data. Such labeled training data may be obtained from the labeled documents 62 which are used to train the classification component 42 that is used to pre-select a set of the top-k classes, or from similar sources. Given trained classifiers, an embedding of the classes can be performed. As examples, one or more of the following method can be used:

1. In the case where all the classifiers have the same type of parameterization (e.g., a normal vector of slope w and scalar offset b in the case of a linear classifier), the parameters (w and b, which may have a value for each dimension in the embedding space) can be concatenated into a single vector to obtain a class embedding.

2. In another embodiment, cross-validation is performed on the training data 62 to obtain an estimate of a confusion matrix C, which measures the confusion between pairs of classes. Values in the matrix can be based on the proportion or number of occurrences for which an image properly labeled with a class x is labeled by the classification component with a class y. The less frequently this occurs, the more distant the classes. The confusion matrix C can be symmetrized by computing a matrix S=(C+C^{T})/2 and each column (or row) of S can be used as an embedding of the class. Thus, each class is assigned a vector of values which correspond to the similarities with each of the other classes. Again, standard metrics such as the Euclidean distance or the cosine similarity can be used to measure the distance between two classes in such an embedded space. Alternatively, to identify the negative classes, the highest confusion values from the vector can be used.

As with the positive class, given a positive class, negative classes can be drawn uniformly (and randomly) from the corresponding pool of negative classes or selected with a probability (or weighting) derived from the class distances.

Trade-Off when Generating Gold Questions

The measures of popularity and class distance are combined to find a balance for gold questions. As mentioned above, gold questions should display a trade-off between being easy enough for workers to obtain a high accuracy (i.e., a good indicator of the worker sincerity) but not too easy in order not to be spotted.

1. Choosing the Positive Classes According to their Popularities

A pool 30 of the p most popular classes is created. With a small p value, easier to label classes are selected, so there is a higher chance that a worker will recognize the class, but this lowers the diversity of gold questions, and the gold question will be easier for the crowdworker to spot after a few HITs. On the other hand, a larger p value increases the diversity in the gold questions (gold questions are more difficult to spot), but the resulting gold questions are more difficult. In one embodiment, p is a fixed value (for example p=10 has been found to strike a good balance between “too easy” and “too difficult” in the 200 class bird-labeling problem). The choice of p can also be based on a threshold on the popularity, for example the pool includes up to p of the most popular classes which exceed the popularity threshold. Validation experiments can be performed to confirm that the value of p is appropriate.

Sampling from this pool 30 is then performed to choose query classes/images. The sampling can be uniform, or biased toward the most popular classes within the pool. In the biased embodiment, the classes with the highest popularity ranking, or other computed popularity measure, are chosen for generating gold questions more frequently than those with lower rankings. In this embodiment, a threshold may be set such that the least popular classes, those below the threshold, are never selected for generating gold questions. As one example, assuming that the popularity is a non-negative value, each class is sampled with a probability that is the popularity of the class divided by the popularity of all classes in the pool. As another example, the ranking or other popularity measure may be used to compute a weighting for each class, and the classes are then sampled in proportion to their class weightings. As a result of the biasing, a class with 2 million hits on an image search may be sampled more often, e.g., twice as often, than a class with 1 million hits.

2. Choosing the Negative Classes Using Distances in an Embedded Space

For each class, a pool of the n most distant classes is created. The value of n is at least equal to the number q of candidate answers minus 1 (for the true answer). For example, where there are 5 possible answers to each question, n is at least 4. In some embodiments, n>q−1. As with the selection of p, there is a trade-off in selection of the value n. A large n makes the tasks more difficult but introduces more variety, making the gold question more difficult to spot. A small value of n makes the tasks easier but less varied. The value of n may be the same for all classes or might be class-dependent. It may be a fixed value (for example, n=10 was found to strike a good balance between “too easy” and “too difficult” in the bird-labelling problem). The choice of n can also be based on a threshold on the distance: only the classes whose distances are further away than a given threshold distance from a class can be added to the negative pool of that class. Also, as is the case for the positive classes, negative classes may be sampled at random from the pool or the sampling may be biased using the class distance to increase the probability of selection of classes which are further away.

### Multiple Gold Questions in a Single HIT

Because of the “too easy—too difficult” trade-off, it may be difficult for even the sincere workers to obtain a very high accuracy on the gold questions. In this case, two or more gold questions may be asked per HIT 18. If the average probability of an incorrect answer to a gold question is ε (such a quantity can be measured, for example, in a pretest labeling session) and it is assumed that the answers to the questions are independent, then the probability of having m incorrect answers to m gold questions is ε^{m}. The number m of gold questions in a HIT may be chosen such that ε^{m} is lower than a pre-defined threshold. For example, if the percentage of errors on a gold question is ε=10% and the aim is to declare a sincere worker to be insincere not more than 1% of the time, then m=2 (or more) gold questions per HIT may be chosen and a worker is considered insincere if all gold questions are answered incorrectly. In other embodiments, a worker is considered sincere if at least one of the m questions is answered correctly. Where a larger number m is selected, the worker may be expected to get two or more gold questions correct to be considered sincere, i.e., so that the worker would need to perform better, on average, than would be obtained by random selection of the answer, since even an insincere worker can be expected to answer some of the questions correctly by chance.

### Classification

The exemplary classification component 42 includes a set of classifiers, one for each class. The classification component uses an algorithm to identify the top k classes, based on the outputs of the classifiers in the set. An exemplary classifier is a linear classifier which computes a kernel (e.g., a dot product) between the image representation and the trained classifier. Based on the computed kernel, the image is assigned to a respective class, or not (a binary decision), or is assigned a probability of being in the class.

Any suitable method for training the classification component 42 can be employed. In the case of images, for example, labeled training images 62 are provided, each training image being labeled with one (generally only one) of the classes in the set 34 of classes. For each training image, a representation, such as a multi-dimensional vector, is generated. The exemplary representation is based on statistics computed for a set of patches extracted from the image, each patch including an array of pixels. Example representations include Fisher Vector representations and Bag-of-Visual-Word representations although other high-level statistical representations are also contemplated. The exemplary image representations are of a fixed dimensionality, i.e., each image representation has the same number of elements, such as at least 50 or at least 100 elements, and in some cases, up to 200,000 elements, or more.

For example, the classifier training component 74 includes a patch extractor, which extracts and analyzes low level visual features of patches of the image, such as shape, texture, color features, combinations thereof, or the like. The patches can be obtained by image segmentation, by applying specific interest point detectors, by considering a regular grid, or simply by the random sampling of image patches. In the exemplary embodiment, the patches are extracted on a regular grid, optionally at multiple scales, over the entire image, or at least a part or a majority of the image.

The extracted low level features (in the form of a local descriptor, such as a vector or histogram) from each patch can be concatenated and optionally reduced in dimensionality, to form a features vector which serves as the global image representation. In other approaches, the local descriptors of the patches of an image are assigned to clusters. For example, a visual vocabulary is previously obtained by clustering local descriptors extracted from training images, using for instance K-means clustering analysis. Each patch vector is then assigned to a nearest cluster and a histogram of the assignments can be generated. In other approaches, a probabilistic framework is employed. For example, it is assumed that there exists an underlying generative model, such as a Gaussian Mixture Model (GMM), from which all the local descriptors are emitted. Each patch can thus be characterized by a vector of weights, one weight for each of the Gaussian functions forming the mixture model. In this case, the visual vocabulary can be estimated using the Expectation-Maximization (EM) algorithm. In either case, each visual word (or cluster) in the vocabulary corresponds to a grouping of typical low-level features. The visual words may each correspond (approximately) to a mid-level image feature such as a type of visual (rather than digital) object. Given an image to be assigned a representation, each extracted local descriptor is assigned to its closest visual word in the previously trained vocabulary or to all visual words in a probabilistic manner in the case of a stochastic model. A histogram is computed by accumulating the occurrences of each visual word. The histogram can serve as the image representation or input to a generative model which outputs an image representation based thereon.

For example, as local descriptors extracted from the patches, SIFT descriptors or other gradient-based feature descriptors, can be used. See, e.g., Lowe, “Distinctive image features from scale-invariant keypoints,” IJCV vol. 60 (2004). The number of patches per image or region of an image is not limited but can be for example, at least 16 or at least 64 or at least 128. Each patch can include at least 4 or at least 16 or at least 64 pixels. In one illustrative example employing SIFT features, the features are extracted from 32×32 pixel patches on regular grids (every 16 pixels) at five scales, using 128-dimensional SIFT descriptors. Other suitable local descriptors which can be extracted include simple 96-dimensional color features in which a patch is subdivided into 4×4 sub-regions and in each sub-region the mean and standard deviation are computed for the three channels (R, G and B). These are merely illustrative examples, and additional and/or other features can be used. The number of features in each local descriptor is optionally reduced, e.g., to 64 dimensions, using Principal Component Analysis (PCA). Representations can be computed for two or more regions of the image and aggregated, e.g., concatenated.

In some illustrative examples, a Fisher vector is computed for the image by modeling the extracted local descriptors of the image using a mixture model to generate a corresponding image vector having vector elements that are indicative of parameters of mixture model components of the mixture model representing the extracted local descriptors of the image. The exemplary mixture model is a Gaussian mixture model (GMM) comprising a set of Gaussian functions (Gaussians) to which weights are assigned in the parameter training. Each Gaussian is represented by its mean vector, and covariance matrix. It can be assumed that the covariance matrices are diagonal. See, e.g., Perronnin, et al., “Fisher kernels on visual vocabularies for image categorization” in CVPR (2007). Methods for computing Fisher vectors are more fully described in U.S. Pub. Nos. 20120076401, 20120045134, Jorge Sanchez, and Thomas Mensink, “Improving the fisher kernel for large-scale image classification,” in Proc. 11^{th} European Conference on Computer Vision (ECCV): Part IV, pages 143-156 (2010), and Jorge Sanchez and Florent Perronnin, “High-dimensional signature compression for large-scale image classification,” in CVPR 2011, the disclosures of which are incorporated herein by reference in their entireties.

Any suitable classifier learning method may be employed which is suited to learning linear classifiers, such as Logistic Regression, Sparse Linear Regression, Sparse Multinomial Logistic Regression, support vector machines, or the like. The exemplary classifier is a binary classifier, although multiclass classifiers are also contemplated. The output of a set of binary classifiers may be processed to assign each image to a predetermined number k of the classes.

While a liner classifier is used in the example embodiment, in other embodiments, a non-linear classifier may be learned.

Further details on classification methods are provided in U.S. Pub. Nos. 20030021481; 2007005356; 20070258648; 20080069456; 20080240572; 20080317358; 20090144033; 20090208118; 20100040285; 20100082615; 20100092084; 20100098343; 20100189354; 20100191743; 20100226564; 20100318477; 20110026831; 20110040711; 20110052063; 20110072012; 20110091105; 20110137898; 20110184950; 20120045134; 20120076401; 20120143853; 20120158739 20120163715, and 20130159292, the disclosures of which are incorporated herein by reference. Given the trained classifiers, the top k classes can be identified for a new image 36, and/or the trained classifiers can be used to identify negative classes, as described above.

Without intending to limit the scope of the exemplary embodiment, the following examples demonstrate the applicability of the method to an image labeling task.

### Examples

Experiments were conducted on a fine-grained classification task, where computer vision techniques are used as an input to generate HITs (Human Intelligence Tasks). The classification task was bird species classification. Experiments were conducted on a benchmark dataset, the Caltech-UCSD 2011 birds dataset, which is composed of 200 bird species. See, Catherine Wah, et al., “The Caltech-UCSD Birds-200-2011 Dataset,” Technical Report CNS-TR-2011-001, California Institute of Technology (2011). The same training and test split used by Wah was employed in the experiments (5994 training images and 5794 testing images). A classification component 42, using a computer vision algorithm, was used to predict the five most likely classes for each image. Each annotator was asked to review these five classes and to mark one of the five if the annotator considers that it belongs to one of the five, or to choose a “none” option otherwise. The aim is to improve the accuracy of the fully automatic classification component 42 with a human in the loop who reviews the most probable classes according to the classification component 42 and chooses the correct one. The task is less tedious for the annotator as the choice is limited to one class out of five instead of 1 out of 200. But the task is still challenging as quite often, classes that have high scores are also difficult to distinguish. So this problem is one where even a motivated worker does not generally get a 100% accuracy.

Each HIT is composed of 3 questions. Two of them (standard questions) are based on query images from the test set. A gold question is placed in each HIT (third question) to assess the motivation of workers. The order of the three questions is randomized. To assist the annotator, an image of a bird prelabeled with the class is provided with each candidate answer (except for the answer “none”). The annotator is also given the opportunity to request one more additional photographs for each bird class. The annotator (typically a crowdworker volunteering to perform the task for a small payment on a crowdsourcing marketplace) is asked to click on one of the answers (one of them being the “none” option).

The protocol for generating a gold question was as follows:

1. A positive class (class of the query image) was randomly selected from the 10 most popular ones, determined based on a Google search.

2. An image for that positive class was randomly selected to be the query image.

3. Four negative classes were randomly chosen from the ten classes that are the most different from the query class according to a semantic distance. In these experiments, an attribute-based distance measure was used, based on a field guide.

4. For each negative class, a predefined representative image labeled with that class was used to assist the annotator.

Results were as follows:

78.3% correct for gold questions

42.5% correct for standard questions

The accuracy for the gold questions is thus significantly higher than for the standard (real) questions. This indicates that the method generates questions that are much easier for the workers than the standard test questions, but ideally not too easy.

As can be seen from an inspection of the classes automatically selected by the system as negative classes, the correct answer is relatively easily identifiable from the given test image, and easy to distinguish from the other choices. In the case of the standard questions, the correct answer is, in comparison with the gold questions, observed to be much harder to solve (see FIG. 2).

An internal study showed that gold questions were difficult to detect in most of the cases, and for most of the annotators.

Additionally, an evaluation was made of the accuracy on the standard questions, considering the subset of images for which the gold question was answered correctly, and incorrectly respectively. These accuracies (43.4% and 39.4% respectively) are comparable, which suggests that the gold questions were not easily detected (and thus workers felt they had to put in an effort to answer all questions) or that there were very few attempts to cheat the system. Still, the accuracy of test questions when gold questions were answered correctly is a few percent higher. Thus, the gold question design likely helps to identify sincere workers. In comparison, the accuracy of a random selection (by a bot) would be less than 17%, while that of a vision-based recognition system is about 30%.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for generating a gold question for a labeling task comprising:
sampling a positive class from a predefined set of classes to be used in labeling documents, based on a computed measure of class popularity;
for the positive class, identifying a set of negative classes from the set of classes based on a distance measure between the positive class and other classes in the set of classes;
generating a gold question which includes a document representative of the positive class and a set of candidate answers, the candidate answers including a label for the positive class and a label for each of the negative classes in the identified set of negative classes; and
outputting the gold question,
wherein at least one of the sampling, identifying, and generating is performed with a computer processor.

2. The method of claim 1, further comprising, for each of the classes in the predefined set of classes, computing the measure of class popularity.

3. The method of claim 1, wherein the sampling of the positive class comprises identifying a set of positive classes from the predetermined set of classes based on a computed measure of class popularity for each of at least some of the classes in the predetermined set of classes and the sampling includes sampling a class from the set of positive classes.

4. The method of claim 1, wherein the sampling of the positive class includes sampling from at least a subset of the classes with a probability that is an increasing function of a computed measure of class popularity for the at least a subset of the classes.

5. The method of claim 1, wherein the measure of class popularity is derived from public resources.

6. The method of claim 1, wherein the measure of class popularity is based on at least one of:
a quantity of hits returned by a search engine when queried with the class label;
a quantity of hits returned by a search engine when queried with the class label for documents of a same type as the documents to be labeled;
a quantity of groups on a document-sharing website that are linked to the class; and
a quantity of documents of the type to be labeled which are submitted to groups on a document-sharing website that are linked to the class.

7. The method of claim 1, wherein the identifying of the set of negative classes comprises at least one of:
identifying a pool of negative classes, the set of negative classes being sampled from the pool, and
sampling negative classes from at least a subset of the set of classes with a probability which is an increasing function of a distance between the sampled positive class and the sampled negative classes.

8. The method of claim 1, further comprising, computing the distance measure between the sampled positive class and other classes in the set of classes.

9. The method of claim 8, wherein the distance measure is computed based on a distance between the positive class and the other classes in an embedding space.

10. The method of claim 1, wherein the method includes, for each of at least some of the classes in the set of classes, computing a feature vector, the distance measure being computed as a function of a distance between the feature vectors.

11. The method of claim 9, wherein the feature vectors include values for a set of features, the features being based on at least one of class attributes and an ontology of classes.

12. The method of claim 1, further comprising generating a labeling task by combining the gold question with a set of standard questions, each of the standard questions including a document to be labeled and a set of candidate answers, the candidate answers including labels for at least a subset of classes from the set of classes.

13. The method of claim 11, wherein the subset of classes for the document to be labeled is identified by classifying the document to be labeled with a classifier.

14. The method of claim 11, further comprising submitting the task to a crowdsourcing marketplace for crowdworkers to perform the task.

15. The method of claim 14, further comprising receiving answers to the gold question and standard questions from a crowdworker and determining a reliability of the crowdworker by comparing an answer to the gold question with the label of the for the positive class.

16. The method of claim 1, wherein the documents to be labeled comprise photographic images.

17. A computer program product comprising a non-transitory recording medium storing instructions, which when executed on a computer causes the computer to perform the method of claim 1.

18. A system comprising memory which stores instructions for performing the method of claim 1 and a processor in communication with the memory for executing the instructions.

19. A system for generating a gold question for a labeling task comprising:
a positive class selector for sampling a positive class from a predefined set of classes to be used in labeling documents, the sampling being based on a computed measure of class popularity;
a negative class selector for identifying a set of negative classes from the predefined set of classes based on a distance measure between the positive class and other classes in the set of classes;
a gold question generator which generates a gold question that includes a document representative of the positive class and a set of candidate answers, the candidate answers including a label for the positive class and a label for each of the negative classes in the identified set of negative classes;
a task outsource component which outputs a task including the gold question; and
a computer processor which implements the positive class selector, negative class selector, and gold question generator.

20. The system of claim 19, wherein the system further comprises a task generator which generates the task by combining the gold question with a set of standard questions, without distinguishing between the gold question and the standard questions in the task, each of the standard questions including a document to be labeled and a set of candidate answers, the candidate answers including labels for at least a subset of classes from the set of classes.

21. The system of claim 19, further comprising a classification component which identifies a set of class labels for each of the standard questions based on the respective document to be labeled.

22. A method for generating a human intelligence task comprising:
computing a measure of popularity for each of a set of classes to be used in labeling documents;
sampling a positive class from the set of classes based on the computed measure of popularity;
identifying a set of negative classes from the set of classes based on a distance measure between the positive class and other classes in the set of classes;
generating a gold question which includes a document representative of the positive class and a set of candidate answers, the candidate answers including a label for the positive class and a label for each of the negative classes in the identified set of negative classes; and
generating a human intelligence task comprising combining the gold question with a set of standard questions, each of the standard questions including a document to be labeled and a set of candidate answers, the candidate answers including labels for at least a subset of classes from the set of classes; and
outputting the human intelligence task,
wherein at least one of the computing, sampling, identifying, generating the gold question, and generating the task is performed with a computer processor.
